(19) United States
(12) Patent Application Publication
(10) Pub. No.: US 2004/0168708 A1
(43) Pub. Date: Sep. 2, 2004

(54) Method for cleaning surfaces,metallic surfaces in particular

(76) Inventors: Franck Rouppert, Bressieux (FR); Christophe Largeron, Meylan (FR); Annie Rivoallan, Villebon Sur Yvette (FR)

Correspondence Address: BURNS DOANE SWECKER & MATHIS L L P, POST OFFICE BOX 1404, ALEXANDRIA, VA, 22313-1404, US

(21) Appl. No.: 10/478,775

(22) PCT Filed: May 28, 2002
(86) PCT No.: PCT/FR02/01783

(30) Foreign Application Priority Data
May 28, 2001 (FR) 0106921

(51) Int. Cl. B08B 3/00

(52) U.S. Cl. 134/4; 134/26; 134/34

(57) ABSTRACT

This invention relates to a process for cleaning surfaces, notably metal surfaces.

The process for cleaning a surface on which chemical species Z are fixed via adsorption or chemisorption, is characterised, in that the surface is put into contact with an aqueous solution capable of shifting the adsorption or chemisorption balance of, the chemical species Z to bring them into the aqueous solution, and the aqueous solution comprising chemical species Z is separated from the thus cleaned surface.

It applies to the decontamination of stainless steel surfaces contaminated with caesium via an acidic aqueous solution with a pH of 2 to 4.

### TECHNICAL FIELD

The purpose of this invention is a process for cleaning surfaces, in particular metal surfaces.

It applies to the operating, decontaminating, maintaining and dismantling of installations of the nuclear industry, as well as to the cleaning of metal parts.

### STATE OF THE PRIOR ART

The processes for the decontamination of surfaces, used notably in the nuclear industry bring into action different mechanisms to carry out this decontamination.

Thus, processes using chemical extraction, processes based on applying surface coatings, processes of decontamination via laser, physical and mechanical processes, thermal processes, suction processes and washing processes are known.

Among these processes, the chemical extraction processes use erosion of the superficial layers of the surface to be decontaminated so as to remove the contamination from this surface. This can be obtained via acid erosion, dissolution in an acid or hydrogen peroxide environment, treatment using a mix of alkaline salts, caustic treatments using detergents, chelation using organic chelating agents, oxidation, oxidation-reduction and electro-polishing.

In all of these processes, the purpose is to achieve an erosion of the superficial layers of the surface to be decontaminated, for example the layers of oxidation in the case of metals, which are the seat of contamination.

In the washing methods, hot water, water vapour, superheated steam or highly pressurised water can be used to dissolve the contaminating chemical species and also to erode the superficial layers of the surface to be decontaminated and thus remove the contamination. The aforementioned decontamination processes are described in the document “Decommissioning Technology Descriptions: Decontamination”, DOE, 1 Aug. 2000 [1]

The majority of the aforementioned processes are aggressive to the material to be treated and their purpose is to remove the passive layer or the oxidation layer, seat of the contamination. They are therefore poorly adapted to maintenance decontamination and are inappropriate when the surface properties of the material must be kept.

Thus, in the nuclear fuel cycle industry, the problem of decontaminating oxidised and contaminated steel that can have very thick, superficial layers of oxidation arises when high-temperature (˜300° C.) processes are employed. The processes currently in practice to carry out this decontamination are washing via de-ionised water under pressure and sand blasting, however, these processes are not completely satisfactory insofar as the amount of residual contamination remains too close to the authorised maximums. Moreover, these processes provoke an abrasion of the surface.

Therefore it would be advantageous to benefit from processes for cleaning surfaces, in particular metal surfaces, to enable:

the conservation of the properties of the surface;

the use of existing decontamination equipment;

keeping 1costs down;

extending the service life of equipment in the nuclear field;

limitation of the doses applied by the operating personnel;

the leading to easy-to-manage effluents; and

limited impact on the environment.

### EXPLANATION OF THE INVENTION

The exact purpose of this invention is a process for cleaning a surface, which achieves the aforementioned purposes by using the physicochemical properties of this surface.

According to the invention, the process for cleaning of a surface, upon which chemical species Z are fixed via adsorption or chemisorption, is characterised in that the surface is put into contact with an aqueous solution capable of shifting the adsorption or chemisorption balance of the chemical species Z to bring them into the aqueous solution, and the aqueous solution comprising chemical species Z is separated from the thus cleaned surface.

According to a first means of implementation of this process capable of being used to desorb chemical species fixed via adsorption, the potential of the surface is modified to release the chemical species Z into the aqueous solution.

In this case, the adsorption balance of the chemical species Z is shifted using a solution capable of adjusting the charge of the surface so as to release the chemical species Z.

This technique consists of using the variations of the charge of the double layer of Gouy-Chapman created in an aqueous environment on the surface to desorb the chemical species Z adsorbed on this surface.

When the chemical species are cations and the surface has a negative charge, the negative charge of the surface is reduced using an acidic aqueous solution.

This is the case for example for a stainless steel surface which has negative charges due to the presence of chromium oxide, these charges increasing in accordance with the pH. Thus, the species Z can be released by lowering the pH using an acidic aqueous solution.

According to a second means of implementation of the process of the invention capable of being used to release chemical species fixed via chemisorption, the Lewis acid behaviour of the surfaces to be treated is used to release the chemisorbed chemical species Z.

This is the case for example of chemical species Z fixed to the surface via a chemical reaction of ion exchange between these species Z and moieties F present on this surface, the reaction leading to the release of ions X.

In this case, the chemical species Z are released using a solution comprising ions X to shift the balance of the reaction of the exchange of ions in the direction of release of the chemical species Z.

When the ions X are H⁺ ions this can be carried out using an acidic aqueous solution.

Such release can take place in the case of a stainless steel surface comprising groups of CrOH used as moieties F to fix chemical species Z such as cations, for example Cs⁺, according to the reaction scheme:

CrOH+Cs⁺→CrOCs+H⁺

In the process of the invention, mechanisms for shifting the adsorption or chemisorption balance of the chemical species Z in the desired direction are thus implemented, meaning releasing of the said species into the aqueous solution, using the physicochemical properties of the surface, in particular its charge or its acidic nature as meant by Lewis.

None of the prior art processes exclusively use such properties to shift chemical species into an aqueous solution, without at the same time resorting abrasion or degradation of the treated surface.

To implement the process of the invention, it is important to have details on the physicochemical properties of the surface to be cleaned as regards chemical species Z, and to then choose the solution Z that will likely be able to shift the chemical species Z of the surface to be cleaned.

In numerous cases, this can be carried out using an acidic solution as already described above.

This acidic aqueous solution can be a nitric acid solution or any other acid, strong or weak, with a pH adapted to the material to be treated. Generally, the pH is from 1 to 7.

The pH that is used is chosen so as to provoke the release of the chemical species Z without disassociating other compounds on the treated surface.

The aqueous solution can be applied to the surface to be treated by all known methods such as dipping, sprinkling with or without pressure, and then distributed on the surface to be treated.

The aqueous solution, that carried the desorbed chemical species Z, is then separated from the cleaned surface.

Preferably, the decontaminated surface is then rinsed with water and dried. The rinsing can be carried out with fresh water and the drying can be carried out for example with compressed air.

The process of the invention can be used to clean any material with properties of fixation of chemical species, for example metals, metal alloys, plastic, glass.

It applies to the desorption of all chemical species fixed to the material via chemical or physicochemical reaction. By way of examples of chemical species likely to be shifted by this process, there are metallic ions among which are the cations such as Cs⁺, Co⁺, Pb²⁺, Ag⁺ and Cd²⁺.

By way of example, via the process of the invention, a metal surface in stainless steel contaminated by caesium can be treated simultaneously using the two means of implementation of the process of the invention.

In this case, there are two main moieties on the surface of the stainless steel likely to fix the caesium. These are chromium oxide Cr₂O₃ and chromium hydroxide CrOH. The oxide has a negative global superficial charge which increases with the pH. It is therefore likely to fix the positively charged cation Cs⁺ forming a double layer of Gouy-Chapman, particular as the negative charge increases resulting in a basic pH. The cation Cs⁺ can therefore be desorbed if the pH of the aqueous solution is lowered.

The hydroxide can fix the cation Cs⁺ via the reaction of ion exchange:

Cr—O—H+Cs⁺ [symbol] Cr—O—Cs+H⁺

According to the Le Chatelier's principle, this reaction is shifted to the left, in the direction of the desorption of Cs⁺ if the concentration of H⁺is increased, therefore if shifted towards the acid pHs.

Also, by bringing the stainless steel surface contaminated with caesium into contact with an acidic aqueous solution the caesium in the aqueous solution can be released.

This can be carried out using a nitric acid aqueous solution with a pH of 2 to 4.

Thus, the efficiency of the current decontamination treatments via aqueous means can be improved using a slightly acidic aqueous phase.

The process of the invention has numerous advantages. It is easy to implement and is efficient. It uses aqueous solutions that are non-aggressive towards the treated surfaces and has a selectivity as regards the chemical species to be removed. Moreover, it allows the surface properties of the treated material to be maintained and it leads to easy-to-manage effluents as they can be evaporated and introduced for example into the vitrification circuit of the spent nuclear fuel refining installations. Furthermore, it can be implemented into existing decontamination installations.

Other characteristics and advantages of the invention will become clearer upon reading the following description, given simply for illustrative and non-restrictive purposes, in reference to the annexed drawings.

### BRIEF DESCRIPTION OF THE DRAWING

FIG. 1 is a graph illustrating the variation of the decontamination factor for a metal surface contaminated with caesium ions, according to the pH of the aqueous solution used for this decontamination.

### DETAILED EXPLANATION OF AN EMBODIMENT

The application of the process of the invention for decontaminating a stainless steel metal surface contaminated with caesium using an acidic aqueous solution is described below.

For this operation a nitric acidic aqueous solution is used and a study is performed on the influence of the pH of this solution on the decontamination factor DF.

Several samples of stainless steel contaminated with caesium are used and are dipped for 24 hours into a nitric acidic aqueous solution with a pH ranging from 5 to 2.

In each case, the concentration of caesium of the aqueous solution after dipping is determined so as to calculate the decontamination factor. DF which corresponds to the ratio of the quantity of contaminants removed by the solution to be tested and the quantity removed-by fresh water.

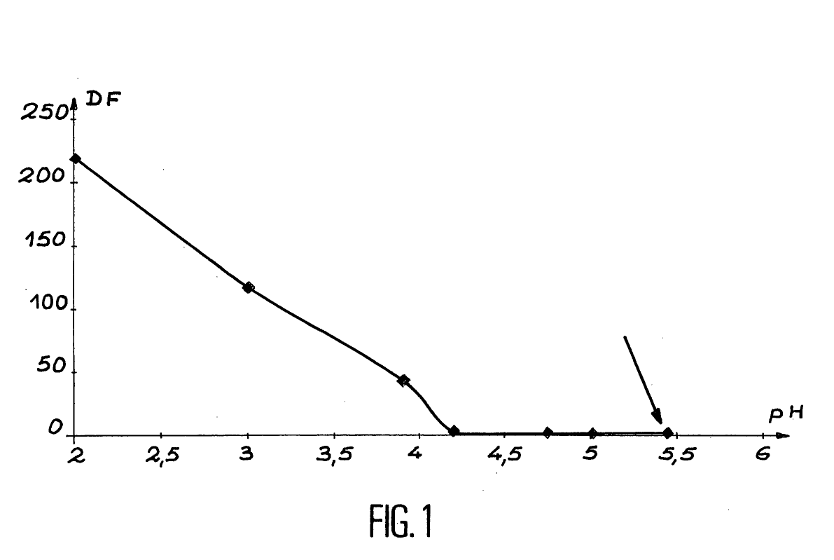

The results obtained are represented in the annexed FIG. 1 which illustrates the evolution of the DF according to the pH of the solution.

In this figure, the arrow refers to demineralized water with a pH of 5.45 usually employed for this decontamination.

Thus, by lowering the pH from 5.45 for demineralized water to 2 it is noted that the efficiency of caesium decontamination of the stainless steel surface is multiplied by more than 200.

Thus, the process of the invention enables removal of the volatile contamination of caesium type to be achieved. No modification to the surface properties of the material are noted.

When this method is used in the nuclear fuel cycle industry, the total residual surface contamination at the end of the treatment can be reduced to very much below allowable standards and therefore:

only a single decontamination operation is necessary, and

plant operating costs are reduced.

Reference mentioned [1] “Decommissioning Technology Description: Decontamination”, DOE, 1 Aug. 2000.

1. Process for cleaning a surface, on which chemical species Z are fixed via adsorption or chemisorption, characterised in that the surface is put into contact with an aqueous solution capable of shifting the adsorption or chemisorption balance of the chemical species Z to bring them into the aqueous solution, and the aqueous solution comprising the chemical species Z is separated from the thus cleaned surface.

2. Process according to claim 1, in which, in addition, the cleaned surface is rinsed with fresh water and dried.

3. Process according to claim 1 or 2, in which the surface is a metal surface.

4. Process according to any one of claims 1 to 3, in which the adsorption balance of the chemical species Z is shifted using a solution capable of adjusting the charge of the surface so as to release the chemical species Z.

5. Process according to claim 4, in which, the chemical species being cations and the surface having a negative charge, the negative charge of the surface is reduced using an acidic aqueous solution.

6. Process according to claim 5, in which the surface is made of stainless steel and has negative charges due to the presence of chromium oxide, these charges increasing in accordance with the pH in such a way that these charges are reduced by bringing the surface into contact with the acidic aqueous solution.

7. Process according to any one of claims 1 to 3, as the chemical species Z are fixed to the surface via a chemical reaction of ion exchange between the species Z and moieties F present on this surface with the release of ions X, a solution containing ions X is used in order to shift the balance of the chemical reaction of ion exchange in the direction of release of the chemical species Z.

8. Process according to claim 7, in which the ions X are H⁺ions and an acidic aqueous solution is used to shift the balance of the reaction of the exchange of ions.

9. Process according to claim 8, in which the surface is made of stainless steel and the moieties F are CrOH groups.

10. Process according to any one of claims 4 to 9, in which the chemical species Z are caesium ions.

11. Process according to claim 10, in which a nitric acid aqueous solution with a pH of 2 to 4 is used.
